(19) United States
(12) Patent Application Publication
(10) Pub. No.: US 2013/0016078 A1
(43) Pub. Date: Jan. 17, 2013

(54) MULTI-PERSPECTIVE IMAGING SYSTEMS AND METHODS

(71) Applicant: Nagendra B. Kodali, Pelham, NH (US)

(72) Inventor: Nagendra B. Kodali, Pelham, NH (US)

(21) Appl. No.: 13/548,989

(22) Filed: Jul. 13, 2012

Related U.S. Application Data
(60) Provisional application No. 61/507,855, filed on Jul. 14, 2011.

(51) Int. Cl. G06F 3/038

(52) U.S. Cl. 345/204

(57) ABSTRACT

Systems and methods of providing views of an object from a viewing apparatus are provided. The viewing apparatus can include a monitor, a mirror, a user interface, and a control unit. The mirror can be disposed proximate to at least a portion of a front surface of the monitor. The user interface can receive an input signal from a user. The control unit can receive the input signal and, based on the input signal, can switch an output of the viewing apparatus between a reflective view of a first portion of an object and a transmissive view of a second portion of the object.

### CROSS REFERENCE TO RELATED APPLICATIONS

This application claims priority under 35 U.S.C. §119(e) to U.S. Provisional Application Ser. No. 61/507,855, titled “Multi-Perspective Imaging Systems and Methods”, by Nagendra B. Kodali, filed Jul. 14, 2011, which is incorporated herein by reference in its entirety.

### BACKGROUND

Mirrors reflect the surfaces of an object that face the mirror. Generally, to see different surfaces of the object, multiple mirrors are used, or the object moves so that a different surface of the object faces the mirror.

### SUMMARY

At least one aspect relates generally to providing views of an object, and more specifically, to providing multiple perspective views of an object.

At least one aspect is directed to a viewing apparatus. The viewing apparatus includes a monitor and a mirror. The mirror can be disposed proximate to at least a portion of a front surface of the monitor. The viewing apparatus can also include a user interface. The user interface can receive an input signal from a user. The viewing apparatus can also include a control unit. The control unit can receive the input signal and, based on the input signal, can switch an output of the viewing apparatus between a reflective view of a first portion of an object and a transmissive view of a second portion of the object.

At least one other aspect is directed to a viewing apparatus that includes a monitor and a mirror. The mirror can be disposed between the monitor and an object. The monitor can display transmissive views of the object. The mirror can reflect reflective views of the object. The viewing apparatus can include a user interface, which can receive an input signal from a user. The viewing apparatus can also include a control unit. The control unit can select an output of the viewing apparatus from one of a reflective view of a first portion of the object and a transmissive view of a second portion of the object.

At least one other aspect is directed to a method of displaying perspective views of an object from a viewing apparatus. The method can include an act of providing, via a mirror, a reflective view of a first perspective of the object, and an act of switching an operational state of the viewing apparatus from a reflective state to a transmissive state. The method can also include an act of providing, via a monitor, a transmissive view of a second perspective of the object that passes through the mirror in the transmissive state.

At least one other aspect is directed to a method of displaying views of an object from a viewing apparatus having a monitor, a mirror disposed proximate to at least a portion of a front surface of the monitor, and a control unit. The method includes an act of configuring the viewing apparatus to display a reflective view of a first perspective of the object. The method can also include an act of switching an operational state of the viewing apparatus from a reflective state to a transmissive state. The method can also include an act of configuring the viewing apparatus to display a transmissive view of a second perspective of the object.

In various embodiments, the aspects described herein can include any combination of the following elements, acts, or embodiments. In one embodiment, the mirror is configured to reflect the reflective view, and the monitor is configured to display the transmissive view through the mirror when for example the mirror is in a transmissive state. The control unit can receive an image signal of the second portion of the object, corresponding to the transmissive view, from at least one imaging device. In some embodiments, an imaging device images (e.g., captures an image of) the second portion of the object and communicates an image signal of the second portion of the object with the control unit. The image signal can be a picture or video of a portion of the object. The control unit can include at least one central processing unit, programmable logic device, processor, computing device, or integrated circuit. The control unit can be a dedicated unit, or can be located in multiple components of the viewing apparatus, such as the monitor, user interface, or the imaging device, where logic devices of these components collectively form the control unit. The control unit may also be part of a computer, such as a personal computer, laptop, desktop, tablet, smart phone, or personal digital assistant. In one embodiment, the control unit and the memory storage unit are part of the same device.

These and other aspects and embodiments are discussed in detail below. The foregoing information and the following detailed description include illustrative examples of various aspects and embodiments, and provide an overview or framework for understanding the nature and character of the claimed aspects and embodiments. The drawings provide illustration and a further understanding of the various aspects and embodiments, and are incorporated in and constitute a part of this specification. The drawings, together with the remainder of the specification, serve to describe and explain the claimed aspects and embodiments.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram depicting a viewing apparatus in accordance with an example;

FIG. 2 is a diagram depicting a viewing apparatus in accordance with an example;

FIG. 3 is a diagram depicting a viewing apparatus in accordance with an example;

FIG. 4 is a diagram depicting a viewing apparatus in a transmissive mode of operation, in accordance with an example;

FIG. 5 is a diagram depicting a viewing apparatus in a reflective mode of operation in accordance with an example; and

FIG. 6 is a flow chart depicting a method of displaying views of an object in accordance with an example.

### DETAILED DESCRIPTION

The systems and methods described herein are not limited in their application to the details of construction and the arrangement of components set forth in the description or illustrated in the drawings. The invention is capable of other embodiments and of being practiced or of being carried out in various ways. Also, the phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate embodiments consisting of the items listed thereafter exclusively. In some embodiments, the systems and methods described herein consist of one, each combination of more than one, or all of the described elements, acts, or components.

A viewing apparatus is provided that can display a reflective view of an object, such as a portion of a person's body, and a transmissive view of the object. For example, the reflective view can be a reflection of an object from a mirror, and the transmissive view can be a digital image (still or video) of the same or a different portion of the object displayed on a monitor, where at least a portion of the transmissive view passes through the mirror. The reflective and transmissive displays can occur sequentially or concurrently, so a person facing the mirror can see both the reflective and transmissive views from a generally fixed position, e.g., sitting or standing.

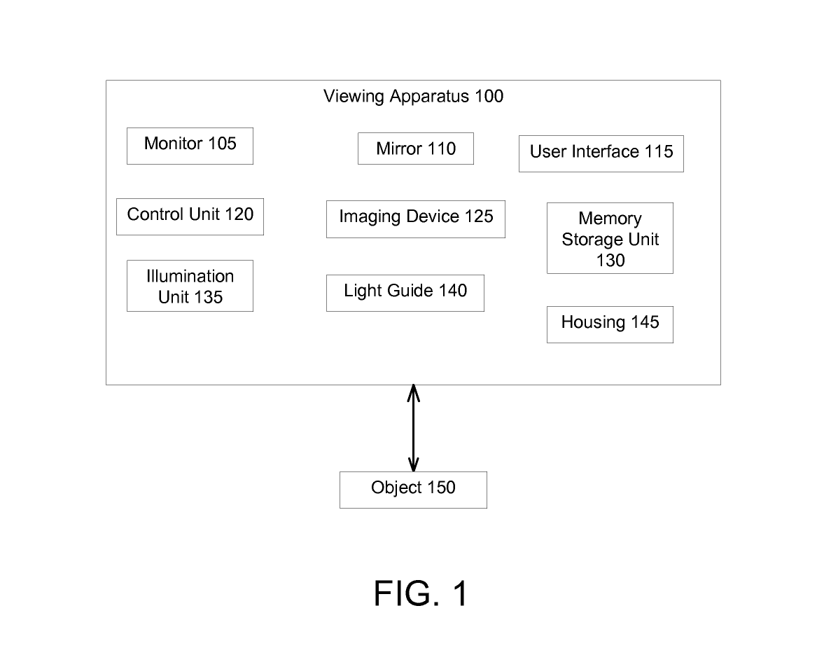

FIG. 1 depicts an example viewing apparatus 100. In some embodiments, the viewing apparatus 100 includes one or more of: at least one monitor 105, at least one mirror 110, at least one user interface 115, at least one control unit 120, at least one imaging device 125, at least one memory storage unit 130, at least one illumination unit 135, at least one light guide 140, and at least one housing 145. The viewing apparatus 100 can display views of at least one object 150, such as a person, place, item or good.

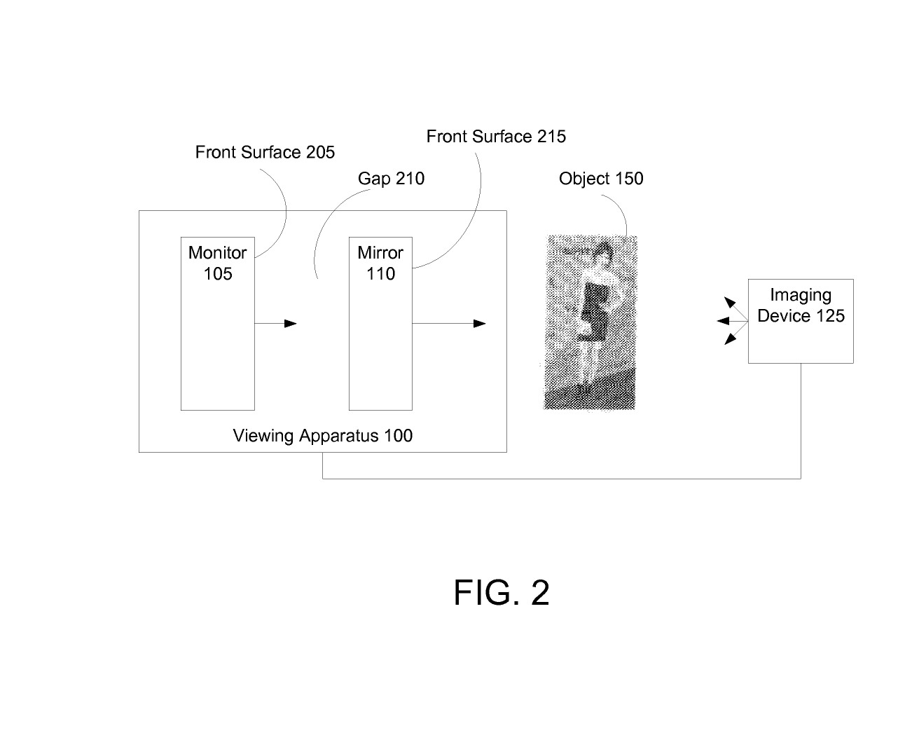

The viewing apparatus 100 can provide perspective views of the object 150. A viewing apparatus 100 can include the monitor 105 and the mirror 110. The mirror 110 provides an image of the object 150 by reflecting the object 150, and the monitor 105 provides an image of the object 150 by displaying a video or still image of the object 150. The mirror 110 can be disposed in front of the monitor 105, and the mirror 110 can change states from a reflective state, where the reflective image of the object 150 is displayed, to a transmissive state, where the mirror's reflective characteristics are replaced with transparent characteristics so that the image from the monitor 105 passes through the mirror 110 (e.g., as in the direction of the arrow emanating from the front surface 215 of the mirror 110 in FIG. 2) and is displayed, for example to the user who may be the object 150. Thus, a user looking at the viewing apparatus 100 can sequentially view the reflective view of the object 150, provided via reflection from the mirror 110, and the transmissive view of the object 150, provided via the monitor 105 and through the mirror 110, by changing operational states of the monitor 105 or the mirror 110. In one embodiment, the monitor 105 and the mirror 110 are separate components of the viewing apparatus 110. For example, the mirror 110 can be a separate component from glass or other material that is part of the front surface 205 of the monitor (as in FIG. 2). In some embodiments, the mirror 110 is an integral part of the monitor 105. For example, a sheet of glass that is part of the front surface 205 of the monitor (e.g., that is viewed to see images) can include the mirror 110. The reflective and transmissive views can be views of different portions or perspectives of the object 150. Accordingly, the user can view different perspectives of the object 150 from the viewing apparatus 100.

The imaging device 125 may be a video camera or still image digital camera, or combinations thereof. The imaging device 125 and the user interface 115 can communicate in a wired or wireless fashion with eachother, the control unit 120 or the monitor 105. The imaging device 125 can also provide an image of the transmissive view of the second portion of the object 150 to the control unit 120. In one embodiment, the imaging device 125 generates an image of the second portion of the object 150 during a time period, and the monitor 105 displays the transmissive view of the second portion of the object 150 during the time period, e.g., in real time, as live or streaming video, or as a series of still images.

The imaging device 125 can be part of the viewing apparatus 100, or a separate component that is connected to the viewing apparatus 100, for example by a cable or wired or wireless communication. The imaging device 125 can be mounted in a fixed position, or in a mobile position so that a user of the imaging device 125, or a subject of the imaging device 125 that may be the object 150, can place the imaging device 125 in a plurality of positions so that different portions of the object 150 can be viewed. There can be multiple imaging devices 125 at different positions to image multiple views of the object 150.

In various embodiments, the viewing apparatus 100 includes an illumination unit 135. The illumination unit 135 can backlight the mirror 110. For example, the illumination unit 135 can illuminate a back surface of the mirror 110. In one embodiment, the illumination unit 135 illuminates a space or gap 210 between the front surface 205 of the monitor 105 and the back surface of the mirror 110. The illumination unit 135 can provide non-polarized or polarized light. In one embodiment, the illumination unit 135 includes a filter that can polarize the light. The illumination unit 135 can include a light source such as at least one of a light bulb, a fluorescent light, or a light emitting diode. In one embodiment, the mirror 110 reflects the reflective view of the first portion of the object 150 in the absence of backlight illumination, and transmits the transmissive view of the second portion of the object 150 in the presence of backlight illumination.

In some embodiments, the viewing apparatus 100 includes a light guide 140. The light guide 140 can be coupled with the illumination unit 135 to illuminate at least a portion of a surface of the mirror 110, such as the back surface that faces the front surface 205 of the monitor 105. For example, the illumination unit 135 can be located such that it does not directly illuminate a gap 210 between the front surface 205 of the monitor 105 and the rear surface of the mirror 110. The light guide 140 can propagate light from the illumination unit 135 into the gap 210. In one embodiment, the light guide 140 propagates ambient light toward a back surface of the mirror 110, for example in the absence of a dedicated illumination unit 135.

In one embodiment, the viewing apparatus 100 includes a gap 210 between a front surface 205 of the monitor 105 and a back surface of the mirror 110, such as an air gap 210. The illumination unit 135 or the light guide 140 can propagate light into the gap 210 in the direction of the arrow emanating from the front surface 205 in FIG. 2, where the light illuminates the back surface of the mirror 110. In one embodiment, the gap 210 between the front surface 205 of the monitor 105 and the back surface of the mirror 110 has a distance of less than 6 inches, and in this example the mirror 110 is disposed proximate to the front surface 205 of the monitor 105. In one embodiment, this distance is less than 1 inch.

In various embodiments, the viewing apparatus 100 includes at least one memory storage unit 130. The memory storage unit 130 can store at least one image of at least a portion of the object 150. For example, a digital picture or video image of a portion of the object 150 can be transmitted from the imaging device 125 to the memory storage unit 130. The memory storage unit 130 can be coupled with the imaging device 125 or the control unit 120. The memory storage unit 130 can be part of the control unit 120. In one embodiment, the memory storage unit 130 is part of the monitor 105. The control unit 120 can access, from the memory storage unit 130, a plurality of stored images of a plurality of different perspective views of the object 150, and can communicate with the monitor 105 to display the plurality of views. This display may occur responsive to input received at the user interface 115.

In one embodiment, the viewing apparatus 100 includes the housing 145. The housing 145 can house the monitor 105, the mirror 110, or both. The housing 145 can include or house the control unit 120. In one embodiment, the mirror 110 covers at least a portion of the front surface 205 of the monitor 105. For example, a user or a subject (e.g., the object 150) facing the mirror 110 will not see the monitor 105, as the monitor 105 can be hidden from the view of the user or subject by the mirror 110. The mirror 110 may have a diagonal length of between 3 inches and 84 inches. These are examples; this mirror length can be less than 3 inches and more than 84 inches. In one embodiment, the mirror 110 has a diagonal length of between 6 inches and 72 inches. The mirror 110 can have various geometric shapes, such as square, rectangular, round, oval, elliptical, triangular, or polygonal. In one embodiment, a front surface 205 of the monitor 105 is aligned with a back surface of the mirror 110. For example, the mirror 110 can be disposed with a front surface 215 of the mirror 110 in parallel or aligned with at least a portion of the front surface 205 of the monitor 105. The front surface 205 of the monitor and the front surface 215 of the mirror are generally the surfaces facing the object 150, or viewable from the perspective of the object 150.

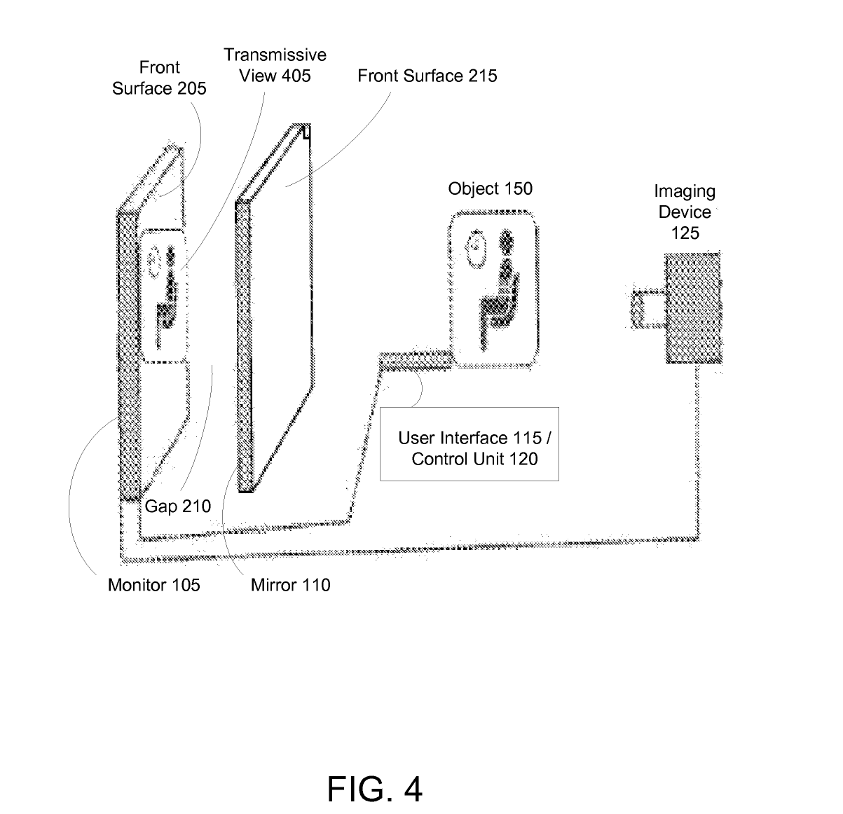

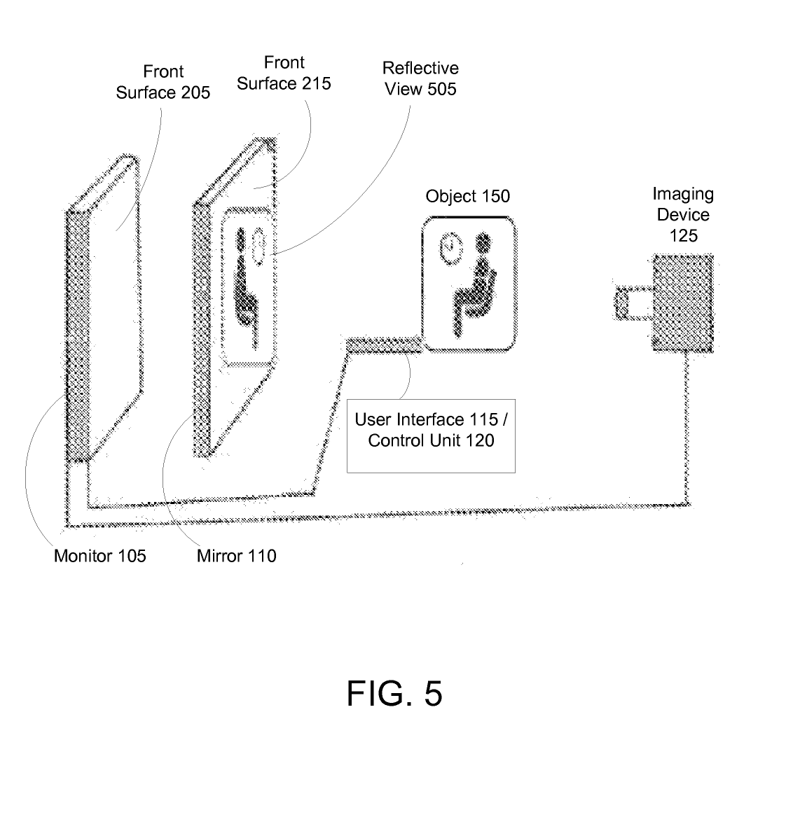

In one embodiment, the control unit 120 configures the viewing apparatus 100 in at least one of a plurality of modes of operation. For example, the control unit 120 can include the user interface 115 and can communicate with logic devices of the monitor 105 or the imaging device 125 to configure the apparatus in a first mode to display the reflective view 505 (as in FIG. 5) and a second mode to display the transmissive view 405 (as in FIG. 4). In a first mode of operation, the mirror 110 can reflect the reflective view 505 of a first portion of the object 150. In a second mode of operation, the monitor 105 can provide the transmissive view 405 of the second portion of the object 150, with the mirror 110 configured to pass the transmissive view of the second portion of the object 150. In this example, with the mirror 110 in the second, transmissive mode of operation, the mirror 110 acts as transparent glass or other material, and the reflective characteristics of the mirror 110 are suppressed. In one embodiment, the viewing apparatus 100 operates in the reflective mode in an OFF state where it is not receiving power or is in a standby mode (e.g., not operational), and in the transmissive mode in an ON state where the control unit 120, monitor 105, or other elements are receiving power and are active. For example, the control unit 120 can provide or control a voltage across at least a portion of the mirror 110, or material between front and back plates of the mirror 110, to change the mirror 110 from a reflective state where a front surface of the mirror 110 (e.g., facing the object 150) reflects an image, to a transmissive state where an image from the monitor 105 transmits through the mirror 110 and can be viewed through the mirror 110 by a person.

The operational state of the viewing apparatus 100 can be changed by controlling voltage or illumination characteristics of the monitor 105 in the absence of changes to the mirror 110, which remains inert or static in this example. The operational state of the viewing apparatus 100 can also be changed by controlling voltage across the mirror 110, for example when the mirror 110 includes electrochromic materials, in the absence of changes to the monitor 105 in this example. In one embodiment, the operational state of the viewing apparatus 100 changes when one of the mirror 110 and the monitor 105 is dynamically changed (e.g., by the control unit 120) with the other remaining static. In one embodiment, both the mirror 110 and the monitor 105 are controlled and dynamically changed to switch the operational state of the viewing apparatus 100.

In one embodiment, the control unit 120 changes the operational states of the viewing apparatus 100 responsive to input received at a user interface 115. For example, a user, which may include the object 150 being displayed by the viewing apparatus 100, can engage with the user interface 115 (e.g., press a button, switch, panel, or touch screen) that is part of or connected to the viewing apparatus 100 to instruct the viewing apparatus 100 to switch operational states. In this example, the object 150 can be the user viewing an anterior (e.g., chest or face) reflection of the user in the reflective mode. The user engages the user interface 115 to change operational states, causing the viewing device cease reflecting the anterior view and to display a digital (video or still) image of the user's posterior (e.g., back), in the transmissive operational state. The image of the posterior can be imaged by the imaging device 125 and provided to the monitor 105 by any of the imaging device 125, the control unit 120, or the memory storage unit 130. When, for example, the object 150 is a person, the viewing apparatus 100 can allow the person to view their anterior reflection, change the operational state of the viewing apparatus 100, and view a real time view of their posterior reflection, with the person being substantially stationary. For example, in a substantially stationary position, the person continues to look in the same direction (e.g., at the viewing apparatus 100), and sees a real time image of their posterior, without twisting or head turning. Generally, in this example the only significant motion may be when the person presses a button or otherwise engages the user interface 115 to change operational states. The user interface 115 can be at least one of a button, a switch, a touch pad, a mouse, a foot pad, a smart phone, a handheld electronic device, and a clicker. The user interface 115 can also be voice activated.

In one embodiment, the reflective view of the first portion of the object 150 is an anterior view of a person in a substantially stationary position, and the transmissive view of the second portion of the object 150 is a posterior view of the person in the substantially stationary position. The first and second portions of the object 150 can be mutually exclusive portions of the object 150, or they can at least partially overlap. In one embodiment, the object 150 is the user of the viewing apparatus 100. Other people may assist the user, for example by engaging with the interface device.

In various embodiments, the mirror 110 is constructed at least in part with glass. For example, the mirror 110 can include transflective glass. In one embodiment, the mirror 110 includes at least one of a transflective material, a transflective gel, electrochromic materials, molten salt, or electrochromic materials disposed between a first glass plate and a second glass plate of the mirror 110. The mirror 110 can include auto-dimming glass that modulates the ratio of reflection/transmission for image clarity. The mirror 110 can also include chemically treated glass, or any glass configured to switch between a reflective state and a transmissive state based on polarized light illuminating the glass.

In one embodiment, the monitor 105 is at least one of a flat screen monitor, a liquid crystal display monitor, a high-definition monitor, a light emitting diode monitor, a plasma monitor, a television monitor, and a computer monitor. The monitor 105 can include at least one of a video input, an audio input, a video output, and an audio output. At least part of the control unit 120 can be coupled with the monitor 105, or an integral part of the monitor 105 or its housing 145. In one embodiment, the monitor 105 is configured for wired or wireless communication with at least a portion of the control unit 120. In one embodiment, the viewing apparatus 100 projects at least one of a two dimensional image of a portion of the object 150 and a three dimensional image of a portion of the object 150.

In one embodiment, different perspective views of the object 150 are displayed by switching the operational state of the mirror 110 of the viewing apparatus 100 from the reflective state to the transmissive state. Displaying a view of the object 150 can include acts of receiving an input identifying a selected operational state of the mirror 110 from one of the reflective state and the operational state, and selecting the selected operational state. In one embodiment, one of the reflective view (e.g., reflective view 505) of the first perspective of the object 150 and the transmissive view (e.g., transmissive view 405) of the second perspective of the object 150 is selected. Responsive to a selection of the reflective view, the reflective view can be displayed from the mirror 110, and responsive to a selection of the transmissive view, the transmissive view can be displayed from the monitor 105. The control unit 120 can receive input from the user interface 115 and, responsive to the input, change or maintain operational states of the viewing apparatus 100.

Some embodiments include acts of generating the transmissive view of the second perspective of the object 150, receiving the transmissive view at the control unit 120, and providing the transmissive view to the monitor 105. Various embodiments also include acts of generating the reflective view of the first perspective of the object 150 with the object 150 in a substantially stationary position, or generating the transmissive view of the second perspective of the object 150, with the object 150 in the substantially stationary position. A selection of the operational state can be received from a user. In one embodiment, the viewing apparatus 100 is handheld. In one embodiment, the viewing apparatus 100 is mounted in a wall, the floor, or ceiling of a structure in a substantially permanent location.

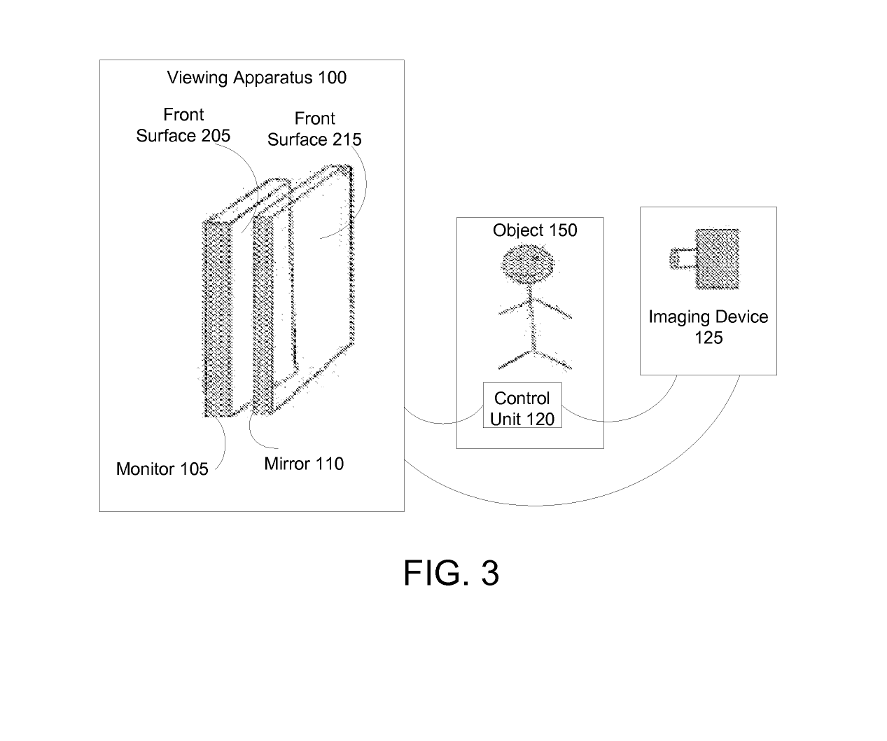

The viewing apparatus 100 can include at least one monitor 105, and at least one mirror 110, with the mirror 110 disposed in front of the monitor 105 relative to the object 150 (e.g., between the monitor 105 and the object 150), such as the person depicted in FIG. 2. At least one imaging device 125, such as a camera, can be part of the viewing apparatus 100 or a separate device connected to the viewing apparatus 100 by a cable or by wireless communication links images taken by the imaging device 125 can be received by the control unit 120, for example contained in the monitor 105 when the mirror 110 is in the reflective state. With reference to FIGS. 2-5, the object 150, e.g., a person, faces the mirror 110 so that the mirror 110 reflects the person's anterior. This reflection is visible to the person in this example. The imaging device 125 (e.g., a digital camera or video camera) in this example images the person's posterior and provides this image to the monitor 105. When the person wishes to see their posterior, the person (or another person such as an assistant or service provider) engages the user interface 115 (e.g., a clicker) that may be part of the control unit 120 to instruct the viewing apparatus 100 to change the state of the mirror 110 from a reflective state to a transmissive state. The monitor 105 displays the posterior image with the mirror 110 in the transmissive state so that the posterior image is displayed from the viewing apparatus 100. The person then views their posterior image while in substantially the same position that they are in when viewing their anterior (reflected) image. The person can switch back and forth between images by manipulating the user interface 115 to send control signals to the control unit 120.

For example, a woman trying on a dress in a store, as depicted in FIG. 2, can see her anterior reflection in a natural standing pose, and then see her posterior image in the same natural pose, without having to twist her head and shoulders relative to her waist to look over her shoulder or see her reflection in multiple mirrors, which alters the posterior view into an unnatural pose. Thus, the woman remains substantially stationary, so that with the exception of minor movement to control the user interface 115 (e.g., clicker) or other inconsequential movement, she is stationary. The woman, or other person engaging the user interface 115, can switch back and forth between one or more reflective or transmissive views of different portions of her body, or any other object 150 that is the subject being reflected or imaged by the viewing apparatus 100. In this example, the woman can see the natural fitting of the clothes on her body in a position of her choosing.

FIG. 4 depicts the transmissive view provided by the monitor 105, with the mirror 110 being transparent in this embodiment, and with the transmissive image being taken by an imaging device 125, such as a camera that is turned on and actively recording images of the object 150. In one embodiment, the transmissive view includes objects superimposed on the image taken by the imaging device 125. For example, when the imaging device 125 captures the image of the back of the head of a person getting or about to get a haircut, the control unit 120 may superimpose a proposed hair style onto the back of the person's head, so that the person may see how they would look with that hairstyle. The superimposed image can replace at least a portion of the underlying image, or the underlying image can remain visible concurrently with (e.g., underneath) the superimposed image. Image registration may be used to align the image of the back of the person's head with the superimposed image, e.g., the proposed hair style. FIG. 5 depicts the reflective view provided by the mirror 110, with the mirror 110 being reflective in this embodiment. In one embodiment, the monitor 105 is powered off or not displaying an image when the viewing apparatus 100 is in the reflective state so as not to interfere with the reflected image by, for example, emanating light toward the mirror 110.

The control unit 120 can change the characteristics of the mirror 110, responsive for example to input received from the user interface 115. For example the mirror 110 may include transflective glass that reflects in the absence of backlight, and is transmissive or generally transparent in the presence of backlight. The backlight can be provided by an illumination unit 135 that illuminates the back surface of the mirror 110, (e.g., the surface of the mirror 110 facing the monitor 105 in FIGS. 2-5). In one embodiment, the control unit 120 controls operation of the backlight, responsive for example to user input received from the user interface 115. In one embodiment, a wave guide or light guide 140 assists in propagating light from the illumination unit 135 to the back surface of the mirror 110. In one embodiment, light from the monitor 105 when displaying an image is the backlight that illuminates the mirror 110 so that turning the monitor 105 on causes the mirror 110 to operate in a transmissive state where the material of the mirror 110 is generally transparent and the monitor image is displayed and visible to one looking at the monitor 105.

In one embodiment, the mirror 110 includes auto-dimming glass. The control unit 120 can adjust the level of dimming of the glass to modulate a ratio of reflection or transmission to change operational states and provide a clear image or reflection of the person or other object 150 being imaged. In one embodiment, the object 150 is the primary focus of the imaging device 125 and the focus of the display that is output by the viewing apparatus 100, so that different portions of the same object 150 can be viewed from the same device, regardless of other background items or other things that may surround the object 150. In one embodiment, the viewing apparatus 100 displays views of different portions of the outer surface of the object 150, such as an anterior of the object 150 and a posterior of the object 150.

In one embodiment, the object 150 being displayed by the viewing device is a person. For example, the person can be in a salon, barber shop, spa, hair styling salon, gym, fitness, center, department store, clothing store, shoe store, theater or studio green room, hospital, doctors office, make up room, class room, or dressing room where the person desires to see multiple views of their body generally from one relaxed pose, such as standing or sitting.

In one embodiment, the viewing apparatus 100 is a single device system that enables one to view and record an image of oneself from any angle. A configuration of the mirror 110, the monitor 105 such as a flat panel digital monitor, and an imaging device 125 such as a movable camera can be controlled by the control unit 120 to create, for example, a reflected frontal image or a projected image of the object 150 or person from any angle.

In one embodiment, the control unit 120 adjusts the size, configuration, or scale of the image captured by the imaging unit. For example, the control unit 120 can convert a digital image of a portion of the object 150 from a landscape format to a portrait format. In this example, the control unit 120 generates a transmissive view of part of the object 150 in the portrait format that corresponds more closely in size and appearance with a reflective view of another portion of the object 150 that may also be in a portrait format. The scale of the reflective and transmissive views can be the same, substantially the same (e.g., within +/−10% in size relative to eachother) or different (e.g., having more than a +/−10% size differential relative to eachother). The reflective view can be in a portrait format with the transmissive view being in either a portrait format or a landscape format. The reflective view may also be in a portrait format.

A reflective view of a first portion of the object 150 can be in a portrait format that appears larger than a landscape transmissive view of a second portion of the object 150. In one embodiment, the control unit 120 adjusts the size of the transmissive view so that the portion of the object 150 displayed in the transmissive view is substantially equal in size (e.g., within +/−10%) to the portion of the object 150 displayed in the reflective view. This adjustment may include converting the transmissive view from a landscape format to a portrait format, enlarging the object 150 in a landscape format, or converting the transmissive view from a landscape format to a portrait format and also enlarging or reducing at least a portion of the converted (e.g., portrait) image. The monitor 105 may be larger than the boundaries of the transmissive image. For example, the entire transmissive image including the object 150 and its surroundings can be displayed by less than all of the pixels of the monitor 105, with pixels of the monitor 105 (e.g., in vertical or horizontal strips along the edges of the monitor 105) configured by the control unit 120 to output black, white, or other colors or patterns. In one embodiment, the portion of the monitor 105 surrounding the transmissive view, that does not display the transmissive view, displays advertisements or other information such as news headlines.

The mirror 110 reflects the surface of the object 150 that faces the mirror 110. For example, a person facing the mirror 110 can see a reflection of the anterior or front half of their body and not an undisturbed and complete image of the back. The viewing apparatus 100 can reflect images and display digital images of the anterior side, posterior, or lateral side of the object 150, such as a person. This allows multiple perspective views of the object 150 while preserving the ambiance and simple beauty associated with a single apparatus that includes the mirror 110 being disposed in front of the object 150 and conserves space. In one embodiment, the object 150 is a person who can view an unperturbed view of self from any direction in the same display window e.g., (the monitor 105 with a minor disposed in front of it or framed together with it) without the person turning their head. This orientation of the mirror 110 and monitor 105 gives the viewing apparatus 100 the look and feel of a mirror as opposed to a TV or computer monitor.

In one embodiment, the monitor 105 and the imaging device 125 (e.g., camera) are connected to power outlets or battery powered. The viewing apparatus 100 can have a plurality of operating states: e.g., ON (or transmissive) and OFF (or reflective). When the device is in the OFF state, the one facing the mirror 110 would see one's expected normal reflected image of the anterior. In the ON position, one would see one's projected image on the monitor 105 behind the mirror 110 based on the location of the imaging device 125 (e.g., the camera angle) and output image that the monitor 105 receives as input. A hand or foot operated user interface 115 (e.g., clicker) can be used by the operator to switch between the two states by powering up or powering down the monitor 105 or by controlling the mirror 110. The camera's power supply could also be controlled by the same clicker. The size of the mirror can vary from 3 inches to 84 inches along a diagonal length depending on market demand and the purpose.

In one embodiment, the mirror 110 functions as a reflecting mirror in the absence of a light source (e.g., monitor 105) from behind the mirror 110; and the mirror 110 functions as a transmissive device that allows the light (from the image of the monitor 105) to pass through the mirror 110 when the monitor 105 is illuminated. The mirror 110 may include at least one surface that is chemically treated with a transflective material so that the finished glass can act as a reflecting mirror in the absence of illumination or transparent glass in the presence of illumination of the back surface of the mirror 110. Polarized light may also be used to switch the glass between reflective and transmissive states. In one embodiment, the mirror 110 is an electro-chromic transflective mirror that includes at least two plates of glass with a layer of transflective gel or molten salts between the plates of glass. The ratio of reflectivity to transmissivity can be changed through application of voltage across the gel.

In one embodiment, the monitor 105 is a liquid crystal display (LCD) or light emitting diode (LED) flat panel high definition (HD) display with video and audio input. The monitor 105 may include at least part of the control unit 120 or other logic device. The monitor 105 can receive video and audio input wirelessly as well. In one embodiment, the mirror 110 and monitor 105 are framed together as a single unit, for example mounted in the housing 145 or a case in a fixed position relative to eachother.

In one embodiment, the imaging device 125 is a video camera or a still camera capable of transmitting output to the monitor 105 either through a cable or wirelessly. The camera can either be at a fixed position, for example behind the object 150 or movable around the object 150 to cumulatively produce a 360 degree view. The initial positioning of the camera can be attached to the control unit 120, mirror 110, or monitor 105, and can be extended behind the person before use. The camera can also be fixed at a permanent location behind the person using it, such as mounted to a wall in a visible or hidden location. In one embodiment, the imaging device 125 is a smart phone having a digital still or video camera. The imaging device 125 can communicate with the monitor 105 via the control unit 120 using a wireless connection, such as a local or wide area network connection, the internet, or a mobile telephone voice or data network.

In one embodiment, the memory storage unit 130 stores a video clip or series of still images captured by the imaging device 125. The monitor 105 can display these images in real time or after a delay period by retrieving them from the memory storage unit 130, for example under the control of the control unit 120. Images can be recorded by the memory storage unit 130 or displayed from the viewing apparatus 100 in real time.

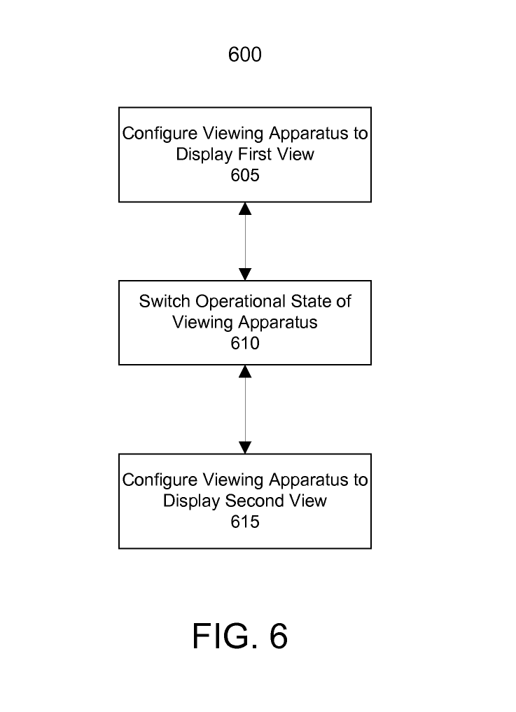

FIG. 6 illustrates a method 600 of displaying views of an object in accordance with an example. In one embodiment, the method 600 displays views of an object from a viewing apparatus having a monitor, a mirror disposed proximate to at least part of the front surface 205 of the monitor, and a control unit. The viewing apparatus can also include or communicate with an imaging device such as a still or video camera. For example, the mirror can be adjacent to all or part of the surface of the monitor that displays a still or video image to a user. The mirror may touch the monitor, or be adjacent to the monitor. There can also be a gap between the front surface of the monitor and the mirror.

The method 600 can configure the viewing apparatus to display a first view of an object (ACT 605). The first view can be a reflective view or a transmissive view. For example, the viewing apparatus can be configured by a control unit provide a first view that is a reflective view of a first perspective of an object (ACT 605). In some embodiments, the viewing apparatus is configured to display a reflective view (ACT 605) of a perspective of an object, such as a front surface of an object facing the mirror.

The method 600 can switch operational states of the viewing apparatus from a first state to a second state (ACT 610). For example, the control unit can configure at least one of the monitor or associated illumination (e.g., by turning off the monitor or an illumination source) and the mirror (e.g., by manipulating a voltage across the mirror to place the mirror in a reflective state) to configure the viewing apparatus in a reflective state (ACT 610) to display a first (e.g., reflective) view of the object (ACT 605). In one embodiment, the control unit can configure at least one of the monitor or associated illumination (e.g., by turning on the monitor or an illumination source) and the mirror (e.g., by manipulating a voltage across the mirror to place the mirror in a reflective state) to configure the viewing apparatus in a transmissive state (ACT 610) to display a second (e.g. transmissive) view of the object (ACT 615).

The method 600 can configure the viewing apparatus to display a second view of an object (ACT 615). The second view can be a reflective view or a transmissive view of the same perspective of the object displayed in the first view, a different perspective of the object displayed in the first view, or a different object. For example, the viewing apparatus can be configured by a control unit provide a second view that is a transmissive view of a second perspective of an object (ACT 615). In some embodiments, the viewing apparatus is configured to display a transmissive view (ACT 615) of a second perspective of an object, such as a rear surface of an object facing away from (or not facing) the mirror.

In one embodiment, the control unit configures the viewing apparatus to display a second view of an object (ACT 615) that is a transmissive view. For example, the transmissive view can be provided by the monitor of the viewing apparatus that displays a still or video image. The transmissive view can emanate from the monitor and pass through a mirror that is in a transmissive or non-reflective state or mode of operation. The transmissive view from the monitor can be viewed by a person looking at the monitor. The transmissive view can be an image of the same perspective of the object as the reflective view, a different perspective view, or a view of a different object. In some embodiments, the viewing apparatus is configured to display the transmissive view of a perspective of an object, such as a back surface of an object whose front surface is facing the mirror.

In some embodiments, the viewing apparatus is configured to repeatedly switch operational states (ACT 610) between a first view (ACT 605) and a second view (ACT 615) of objects. For example, the control unit (e.g., responsive to human user input) can switch the viewing apparatus from a first (e.g., reflective) state to a second (e.g., transmissive) state and back to the first (e.g., reflective) state for as long as the viewing apparatus remains in operation, or as long as a user desires. The initial state of the viewing apparatus can be either transmissive or reflective. In one embodiment, the control unit receives input identifying a desired operational state. For example, the user can provide input indicating that the user wants to see a reflective or transmissive view of the user or another object. The input can be provided to the control unit in the form of at least one toggle, switch, clicker, or button. For example a first input of to the control unit could indicate a reflective view and a second input can indicate a transmissive view, and the user can select the first or second input. Responsive to the input selection, the control unit can configure the viewing apparatus to display the selected view. For example, the control unit can manipulate a voltage across the mirror to change the operational state of the mirror of the viewing apparatus between reflective and transmissive states.

Having now described some illustrative embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one embodiment are not intended to be excluded from a similar role in other embodiments.

Note that in FIGS. 1 through 6, the enumerated items are shown as individual elements. In actual implementations of the systems and methods described herein, however, they may be inseparable components of other electronic devices such as a digital computer. Thus, actions described above may be implemented at least in part in software that may be embodied in an article of manufacture that includes a program storage medium. The program storage medium can be a non-transitory medium and can include non-transitory and other data signals embodied in one or more of a carrier wave, a computer disk (magnetic, or optical (e.g., CD or DVD, or both)), non-volatile memory, tape, a system memory, and a computer hard drive. The program storage medium can include at least non-transient mediums, and the signals can include at least non-transient signals.

From the foregoing, it is appreciated that the apparatus, systems, and methods described herein afford an elegant and effective way for a person in a stationary position to view a reflection of their anterior and, from the same apparatus, view a digital image of their posterior. The systems and methods according to various embodiments are able to provide multiple perspective views from a single device, for example without multiple mirrors positioned around the person. This lets the person view their posterior in a relaxed normal position without excessive twisting or turning that may distort the posterior image and be uncomfortable.

Any references to front and back, left and right, top and bottom, or upper and lower and the like are intended for convenience of description, not to limit the present systems and methods or their components to any one positional or spatial orientation.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act or element may include embodiments where the act or element is based at least in part on any information, act, or element.

Any embodiment disclosed herein may be combined with any other embodiment, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment, inclusively or exclusively, in any manner consistent with the aspects and embodiments disclosed herein.

References to “or” may be construed as inclusive so that any terms described using “or” may indicate any of a single, more than one, and all of the described terms. Intervening embodiments, acts, or elements are not essential unless recited as such.

Where technical features in the drawings, detailed description or any claim are followed by reference signs, the reference signs have been included for the sole purpose of increasing the intelligibility of the drawings, detailed description, and claims. Accordingly, neither the reference signs nor their absence are intended to have any limiting effect on the scope of any claim elements.

The systems and methods described herein may be embodied in other specific forms without departing from the characteristics thereof. For example, multiple imaging devices 125 can image multiple portions of the object 150, so that the viewing apparatus 100 displays more than two perspective views, or displays the same portion of the object 150 (e.g., posterior) from a plurality of different angles. Further, a portion of the viewing device facing the person can include a non-transmissive mirror so that multiple perspectives (e.g., a reflective perspective and a transmissive digital perspective) of the person can be simultaneously displayed. The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A viewing apparatus, comprising:
a monitor;
a mirror disposed proximate to at least a portion of a front surface of the monitor,
a user interface configured to receive an input signal from a user;
a control unit configured to receive the input signal and to switch output of the viewing apparatus between a reflective view of a first portion of an object, and a transmissive view of a second portion of the object, based on the input signal.

2. The apparatus of claim 1, wherein the mirror is configured to reflect the reflective view, and wherein the monitor is configured to display the transmissive view through the mirror.

3. The apparatus of claim 1, wherein the control unit is configured to receive an image signal of the second portion of the object, corresponding to the transmissive view, from an imaging device.

4. The apparatus of claim 1, further comprising:
an imaging device configured to image the second portion of the object and to communicate an image signal of the second portion of the object with at least one of the control unit and the monitor.

5. The apparatus of claim 1, wherein the monitor is configured to provide backlight illumination to the mirror.

6. The apparatus of claim 1, further comprising:
a memory storage unit configured to store at least one image of at least a portion of the object.

7. The apparatus of claim 1, further comprising:
the control unit configured to access, from a memory storage unit, a plurality of stored images of a plurality of different perspective views of the object, and to display the plurality of views responsive to input into the user interface.

8. The apparatus of claim 1, further comprising:
an imaging device configured to provide an image corresponding to the transmissive view of the second portion of the object to the control unit; and
the user interface configured for at least one of wired and wireless communication with at least one of the imaging device and the control unit.

9. The apparatus of claim 1, further comprising:
an imaging device configured to generate an image of the second portion of the object; and
the monitor configured to display the transmissive view of the second portion of the object in real time.

10. The apparatus of claim 1, wherein the mirror has a diagonal length of between 3 inches and 84 inches.

11. The apparatus of claim 1, further comprising:
the mirror configured to reflect the reflective view of a first portion of the object in a first mode of operation; and
the monitor configured to provide the transmissive view of the second portion of the object in a second mode of operation.

12. The apparatus of claim 11, wherein in the second mode of operation, the mirror is configured to pass the transmissive view of the second portion of the object.

13. The apparatus of claim 1, wherein the reflective view of the first portion of the object is an anterior view of a person in a substantially stationary position, and wherein the transmissive view of the second portion of the object is a posterior view of the person in the substantially stationary position.

14. The apparatus of claim 1, wherein the control unit is configured to control the viewing apparatus in a first mode to display the reflective view and in a second mode to display the transmissive view.

15. The apparatus of claim 1, wherein the mirror is configured to reflect the reflective view of the first portion of the object in the absence of backlight illumination, and wherein the mirror is configured to transmit the transmissive view of the second portion of the object in the presence of backlight illumination.

16. The apparatus of claim 1, wherein the transmissive view includes a digital image of the second portion of the object, further comprising the control unit configured to:
superimpose an image over at least part of the digital image of the second portion of the object.

17. A viewing apparatus, comprising:
a monitor configured to display transmissive views of an object;
a mirror disposed between the monitor and the object, the mirror configured to reflect reflective views of the object;
a user interface configured to receive an input signal from a user; and
a control unit configured to select an output of the viewing apparatus from one of a reflective view of a first portion of the object, and a transmissive view of a second portion of the object.

18. A method of displaying views of an object from a viewing apparatus having a monitor and a mirror disposed proximate to at least a portion of a front surface of the monitor, the method comprising:
configuring the viewing apparatus to display a reflective view of a first perspective of the object;
switching an operational state of the viewing apparatus from a reflective state to a transmissive state; and
configuring the viewing apparatus to display a transmissive view of a second perspective of the object.

19. The method of claim 18, further comprising:
switching the operational state of the viewing apparatus from the transmissive state to the reflective state.

20. The method of claim 18, further comprising:
receiving an input identifying a selected operational state of the viewing apparatus from one of the reflective state and the operational state; and
selecting the selected operational state.

21. The method of claim 18, comprising:
selecting at least one of the reflective view of the first perspective of the object and the transmissive view of the second perspective of the object, and further comprising at least one of:
displaying, responsive to a selection of the reflective view, the reflective view from the mirror; and
displaying, responsive to a selection of the transmissive view, the transmissive view from the monitor.

22. The method of claim 18, further comprising:
generating the transmissive view of the second perspective of the object;
receiving the transmissive view at a control unit; and
providing the transmissive view to the monitor.

23. The method of claim 18, further comprising:
generating the reflective view of the first perspective of the object with the object in a substantially stationary position; and
generating the transmissive view of the second perspective of the object, with the object in the substantially stationary position.

24. The method of claim 18, further comprising:
receiving, from a user, a selection of the operational state.

25. The method of claim 18, further comprising:
providing a voltage across the mirror to change the operational state of the viewing apparatus.
